(19) United States
(12) Patent Application Publication
(10) Pub. No.: US 2007/0295246 A1
(43) Pub. Date: Dec. 27, 2007

(54) Silane-Modified Polyvinylalcohols

(75) Inventors: Andreas Bacher, Burghausen (DE); Karl Ernst Fickert, Altotting (DE); Theo Mayer, Julbach (DE)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMERS SYSTEMS GMBH & CO. KG, Burghausen (DE)

(21) Appl. No.: 11/574,085

(22) PCT Filed: Oct. 20, 2005
(86) PCT No.: PCT/EP05/11305

§ 371 Date: Feb. 22, 2007

(30) Foreign Application Priority Data
Oct. 21, 2004 (DE) 10 2004 051 353.8

(51) Int. Cl. C08F 16/06; C08F 8/12

(52) U.S. Cl. 106/287.26; 525/61

(57) ABSTRACT

Silane-modified polyvinyl alcohols are prepared by copolymerizing a vinyl ester monomer and an epoxy-functional comonomer, reacting epoxy groups with a nucleophilic silane containing at least one alkoxy group, and hydrolyzing to a polyvinyl alcohol copolymer.

The invention relates to silane-modified polyvinyl alcohols, processes for their preparation and their use.

Silane-modified polyvinyl alcohols are known in particular as paper coating materials and are prepared by means of copolymerization of vinyl acetate and ethylenically unsaturated silane and subsequent hydrolysis, or by subsequent silylation of the vinyl alcohol units of polyvinyl alcohol. EP 76490 A1 describes a paper coating material based on silanized polyvinyl alcohols which are obtainable by means of the two process variants. EP 1127706 A1 relates to inkjet recording materials which have a coating of silane-functional polyvinyl alcohol and which are obtainable by the two process variants mentioned. DE 3519575 C2 describes a heat-sensitive recording material having a protective layer which contains a silicon-containing polyvinyl alcohol which is produced by silylation of the vinyl alcohol units or copolymerization with vinylsilane. The silanized polyvinyl alcohols from EP 1380599 A1 are obtained by means of copolymerization of ethylenically unsaturated silanes, polymerization being effected in the presence of mercapto compounds in order to obtain terminally silanized products.

EP 1080940 A2 describes silanized vinyl alcohol-olefin copolymers in coating materials, the silane groups being obtained by copolymerization of ethylenically unsaturated silanes or by subsequent silylation of the vinyl alcohol groups.

WO 2004/013190 A1 describes the preparation of silane-modified polyvinyl alcohol, vinyl esters being polymerized in the presence of silane-containing aldehydes and the vinyl ester polymer obtained thereby then being hydrolyzed.

It was the object of the invention to provide silane-modified polyvinyl alcohols which, in formulations for coating materials, lead to advantageous rheology and to high abrasion resistance of the coating.

The invention relates to silane-modified polyvinyl alcohols obtainable by free-radical polymerization of one or more vinyl esters in the presence of epoxide-functional comonomers, subsequent silylation of the epoxide groups with nucleophilic silane compounds and hydrolysis of the silane-modified vinyl ester copolymers.

Suitable vinyl esters are vinyl esters of straight-chain or branched carboxylic acids having 1 to 18 C atoms. Preferred vinyl esters are vinyl acetate, vinyl propionate, vinyl butyrate, vinyl 2-ethylhexanoate, vinyl laurate, vinyl pivalate and vinyl esters of α-branched monocarboxylic acids having 5 to 15 C atoms, for example VeoVa9® or VeoVa10® (trade names of Resolutions), and 1-alkylvinyl esters with alkyl radicals having 1 to 6 C atoms and of carboxylic acids having 1 to 6 C atoms, such as 1-methylvinyl acetate. Vinyl acetate is particularly preferred.

Suitable comonomers containing epoxide groups are glycidyl acrylate, glycidyl methacrylate, allyl glycidyl ether, vinyl glycidyl ether, vinylcyclohexene oxide, limonene oxide, myrcene oxide, caryophyllene oxide, styrenes and vinyltoluenes substituted by a glycidyl radical in the aromatic, and vinylbenzoates substituted by a glycidyl radical in the aromatic. Glycidyl acrylate and glycidyl methacrylate are preferred. The proportion of the epoxide-functional comonomer units is preferably from 0.01 to 10.0 mol %, based on the total amount of the comonomers.

In addition to the vinyl esters and epoxy-functional comonomers, one or more monomers from the group consisting of methacrylates and acrylates of alcohols having 1 to 15 C atoms, olefins, dienes, vinylaromatics and vinyl halides can, if required, also be copolymerized. Suitable monomers from the group consisting of the esters of acrylic acid or methacrylic acid are esters of straight-chain or branched alcohols having 1 to 15 C atoms. Preferred methacrylates or acrylates are methyl(meth)acrylate, ethyl(meth)acrylate, propyl (meth)acrylate, n-butyl, isobutyl and tert-butyl (meth)acrylate, 2-ethylhexyl(meth)acrylate, norbornyl (meth)acrylate, benzyl(meth)acrylate, 2-hydroxyethyl (meth)acrylate, hydroxypropyl(meth)acrylate, n-hexyl (meth)acrylate, isooctyl(meth)acrylate, isodecyl (meth)acrylate, lauryl(meth)acrylate, methoxyethyl (meth)acrylate, phenoxyethyl(meth)acrylate, isobornyl (meth)acrylate, stearyl(meth)acrylate, cyclohexyl (meth)acrylate, alpha-chloroacrylates and alpha-cyanoacrylates. Methyl acrylate, methyl methacrylate, n-butyl, isobutyl and tert-butyl acrylate, 2-ethylhexyl acrylate and norbornyl acrylate are particularly preferred.

Suitable dienes are 1,3-butadiene, chloroprene and isoprene. Examples of polymerizable olefins are ethene, propene and isobutylene. As vinylaromatics, styrene and vinyltoluene can be incorporated as polymerized units. From the group consisting of the vinyl halides, vinyl chloride, vinylidene chloride or vinyl fluoride is usually used, preferably vinyl chloride. The proportion of these comonomers is such that the proportion of vinyl ester monomer is >50 mol % in the vinyl ester polymer.

If required, further comonomers in a proportion of, preferably, from 0.1 to 25 mol % may also be present. Examples of these are ethylenically unsaturated mono- and dicarboxylic acids, preferably acrylic acid, methacrylic acid, fumaric acid and maleic acid; ethylenically unsaturated carboxamides and carbonitriles, preferably N-vinylformamide, acrylamide and acrylonitrile; mono- and diesters of fumaric acid and maleic acid, such as the diethyl and diisopropyl esters and maleic anhydride, ethylenically unsaturated sulfonic acids and salts thereof, preferably vinylsulfonic acid, and 2-acrylamido-2-methylpropanesulfonic acid. Further examples are alkyl vinyl ethers, such as ethyl vinyl ether, n-butyl vinyl ether, isobutyl vinyl ether, tert-butyl vinyl ether, cyclohexyl vinyl ether, octadecyl vinyl ether, hydroxybutyl vinyl ether, cyclohexanedimethanol monovinyl ether, vinyl methyl ketone, N-vinyl-N-methylacetamide, N-vinylcaprolactam, N-vinylpyrrolidone, N-vinylimidazole.

Precrosslinking comonomers, such as polyethylenically unsaturated comonomers, for example divinyl adipate, diallyl maleate, allyl methacrylate, butanediol diacrylate or triallyl cyanurate, or postcrosslinking comonomers, for example acrylamidoglycolic acid (AGA), methyl methacrylamidoglycolate (MAGME), N-methylolacrylamide (NMA), N-methylolmethacrylamide, N-methylolallyl carbamate, alkyl ethers, such as the isobutoxy ether, or esters of N-methylolacrylamide, of N-methylolmethacrylamide and of N-methylolallyl carbamate, are also suitable. Cationic monomers such as trimethyl-3-(1-(meth)acrylamido-1,1-dimethylpropyl)ammonium chloride, trimethyl-3-(1-(meth)acrylamidopropyl)-ammonium chloride, 1-vinyl-2-methylimidazole and the quaternized compounds thereof, are also suitable.

The vinyl ester copolymers can be prepared in a known manner by means of polymerization; preferably by mass polymerization, emulsion polymerization, suspension polymerization or by polymerization in organic solvents, particularly preferably in alcoholic solution. Suitable solvents and regulators are, for example, methanol, ethanol, propanol and isopropanol. Polymerization is carried out under reflux at a temperature of from 50° C. to 100° C. and initiated by means of free radicals by adding customary initiators. Examples of customary initiators are percarbonates, such as cyclohexyl peroxodicarbonate or peresters, such as tert-butyl per-2-ethylhexanoate, tert-butyl perneodecanoate or tert-butyl perpivalate.

Preferably, polymerization is effected to a degree of polymerization of from 100 to 5000. The molecular weight can be adjusted in a known manner by means of the solvent content, by variation of the initiator concentration, by variation of the temperature and by addition of regulators. The monomers can be initially introduced all together, metered in all together or initially introduced in portions and the remainder metered in after the initiation of the polymerization. The metering operations can be carried out separately (with respect to space and time) or some or all of the components to be metered can be metered as a mixture or in preemulsified form.

The silanization of the epoxide-functional vinyl ester copolymer is preferably effected in alcoholic solution, for example in methanol, and at temperatures of from 20° C. to 70° C., depending on the alcohol, and with addition of bases, for example NaOH, KOH or NaOCH₃. After the reaction, the batch is neutralized and the silanized vinyl ester copolymer is isolated as a solid. The amount of nucleophilic silane compounds used depends on how high the content of epoxide-functional monomer units in the vinyl ester copolymer is. The nucleophilic silane compound is preferably used in molar excess, in particular in a molar excess of from 5 to 20%, based in each case on the epoxide-functional comonomer.

Suitable nucleophilic silane compounds are silanes substituted by aminoalkyl, hydroxyalkyl or mercaptoalkyl radicals and having at least one alkoxy group and in each case from 1 to 6 C atoms in the alkyl radical or alkoxy radical. Aminoalkoxysilanes, aminoalkyldialkoxyalkylsilanes, aminoalkyldialkylalkoxysilanes, mercaptoalkylalkoxysilanes, mercaptoalkyldialkoxyalkylsilanes, mercaptoalkyldialkylalkoxysilanes, hydroxyalkylalkoxysilanes, hydroxyalkyldialkoxyalkylsilanes, hydroxyalkyldialkylalkoxysilanes having in each case from 1 to 6 C atoms in the alkyl radical or alkoxy radical are preferred. 3-(2-aminoethylamino)propyltrimethoxysilane, aminopropyltriethoxysilane, aminopropyltrimethoxysilane, aminomethyltrimethoxysilane, aminomethyltriethoxysilane, aminomethyldiethoxymethylsilane, mercaptopropyltrimethoxysilane and mercaptopropyltriethoxysilane are particularly preferred.

The hydrolysis of the silane-modified vinyl ester copolymers is effected in a manner known per se, for example by the belt or kneader method, in the alkaline or acidic range with addition of acid or base. Preferably, the silane-modified vinyl ester copolymer is taken up in alcohol, for example methanol, a solids content of from 15 to 70% by weight being established. The hydrolysis is preferably carried out in the basic range, for example by addition of NaOH, KOH or NaOCH₃. The base is generally used in an amount of from 1 to 5 mol % per mole of ester units. The hydrolysis is carried out at temperatures of from 30° C. to 70° C. After the end of the hydrolysis, the solvent is distilled off and the polyvinyl alcohol is obtained as powder. The silane-modified vinyl ester copolymer can, however, also be obtained as an aqueous solution by successive addition of water while the solvent is being distilled off.

The silane-modified polyvinyl alcohols generally have a degree of hydrolysis of from 50 mol % to 99.99 mol %, particularly preferably from 70 mol % to 99 mol %, most preferably of >96 mol %. Fully hydrolyzed polyvinyl alcohols are defined as those polymers whose degree of hydrolysis is >96 mol %. Partly hydrolyzed polyvinyl alcohols are to be understood as meaning those having a degree of hydrolysis of >50 mol % and <96 mol %. The viscosity of the polyvinyl alcohol (DIN 53015, Höppler method; 4% strength solution in water) is from 1 to 60 mPas, preferably from 1 to 6 mPas, and serves as a measure of the molecular weight and of the degree of polymerization of the partly or fully hydrolyzed polyvinyl alcohols.

The silanized polyvinyl alcohols can be used in all applications where silane-modified polyvinyl alcohols are customary. In particular, as an additive in aqueous coating systems for the production of recording materials, such as photographic layers and inkjet recording layers and as an additive for the production of primers or sizing agent for release paper stock. The silane-containing polyvinyl alcohols are also suitable as protective colloids in polymerization and as a constituent in formulations of adhesives and of coating materials for packaging materials, building materials, ceramic, glass and wood, for example glass fiber binder and glass adhesive. A further application is that as a binder for formulations of agrochemicals.

### EXAMPLE 1

392.1 g of methanol, 6.46 g of glycidyl methacrylate and 322.8 g of vinyl acetate were initially introduced under nitrogen into a thermostated laboratory apparatus having a capacity of 2.5 liters. 757 mg of tert-butyl perpivalate were added with stirring, and the batch was heated to 58° C. and kept at 60° C. during the reaction.

30 min after the beginning of the reaction, a further 1.30 g of tert-butyl perpivalate were added. After a further 30 min, a mixture of 18.8 g of glycidyl methacrylate and 940 g of vinyl acetate was metered in over a period of 165 min at a rate of 348.7 ml/h. At the same time, a further 759 mg of tert-butyl perpivalate were added. 434 mg portions of tert-butyl perpivalate were added 75 min and 105 min after the beginning of the reaction, 217 mg after 135 min and 110 mg portions 165 min, 195 min and 230 min after the start of the reaction. 270 min after the beginning of the reaction, 326 g of methanol were added to the batch. After a reaction time of 420 min, the batch was cooled.

In a laboratory reactor having a capacity of 2.5 liters, 230 g of the methanolic polyvinyl acetate solution were diluted with a further 877 g of methanol. The solution was heated to 60° C. and 5.01 g of 3-(2-aminoethylamino)propyltrialkoxysilane were added.

After a reaction time of 2 h, the batch was cooled to 30° C. and 104.75 g of methanolic NaOH were added (7.21 g of NaOH, 46% strength in water, dissolved in 97.54 g of methanol). The solution became increasingly turbid. During the gel phase the stirrer was set to a higher speed in order to comminute the gel. After the gel phase the reaction was allowed to continue for a further 2 hours, neutralization was effected with acetic acid and the solid formed was filtered off, washed and dried.

A fully hydrolyzed polyvinyl alcohol having a Höppler viscosity of 6 mPas (according to DIN 53015, as a 4% strength by weight solution in water) was obtained.

### EXAMPLE 2

612 g of water, 61.2 mg of copper(II) acetate and 61.2 g of a 5% strength polyvinylpyrrolidone solution (PVP-K90) in water were initially introduced under nitrogen into a thermostated laboratory apparatus having a capacity of 2.5 liters. A solution of 620 mg of tert-butyl per-2-ethylhexanoate (TBPEH 99% strength from Peroxid-Chemie GmbH), 322 mg of tert-butyl perneodecanoate (Pergan PND, 95% strength), 6.46 g of glycidyl methacrylate and 42.8 g of isopropanol in 612 g of vinyl acetate was allowed to run in with stirring. The reactor was heated to 51.5° C. and, after the reaction had slowed down, heating was carried out stepwise to 75° C. This temperature was maintained for a further 2 hours, followed by cooling. The polymer beads formed were filtered off with suction, washed thoroughly with water and dried.

90 g of polymer beads were dissolved in 810 g of methanol at 50° C. in a laboratory reactor having a capacity of 2.5 liters. The solution was heated to 60° C. and 0.603 g of 3-(2-aminoethylamino)propyltrialkoxysilane was added. After a reaction time of 2 h, the batch was cooled to 30° C., a layer of 500 g of methanol was introduced on top with the stirrer stationary, and methanolic NaOH was immediately added (10 g of NaOH, 46% strength in water, dissolved in 90 g of methanol) and the stirrer was switched on. The solution became increasingly turbid. During the gel phase, the stirrer was set to a higher speed in order to comminute the gel. After the gel phase, the reaction was allowed to continue for a further 2 hours, neutralization was effected with acetic acid and the solid formed was filtered off, washed and dried.

A fully hydrolyzed polyvinyl alcohol having a Höppler viscosity of 27 mPas (4% strength in water) was obtained.

Testing of the Use in Inkjet Recording Layers:

Coating slip formulation:

| | | |
|---|---|---|
| Precipitated silica | 100 | parts by weight |
| Si-PVAL (example 1) | 28 | parts by weight |
| Cationic dispersant | 5 | parts by weight |
| Polymer dispersion | 12 | parts by weight |
| Solids content of the coating | 30% | by weight |
| slip: | | |

Base Paper:
Sized paper about 80 g/m²; coat about 15 g/m²
Testing:
Abrasion Test:

A 4.5 cm wide and 19 cm long paper strip coated with the coating slip was processed by means of 50 strokes in an abrasion tester from Prüfbau (Dr. Dürner system) with a black drawing paper applied to a stamp (500 g). The resulting black paper was then assessed visually, the rating 1 representing the optimum.

Brightness:

This was determined by means of reflectance measurement using a filter (R 457) and was visually assessed, a rating of 1 representing the optimum.

Results:

| Coat analysis | Example 1 |
|---|---|
| Abrasion test | 1 |
| Brightness, visual | 1 |
| Brightness R457 | 5.2 |

Testing of the Use in Release Paper Stocks:
Production of the Paper:

The primer (solution of Si-PVAL from example 2) was applied to a base paper by means of a laboratory size press and appropriately dried (coat weight 1.5 g/m² to 3 g/m²). A release layer comprising 100 parts by weight of a vinyl-terminated polysiloxane (dehesive 920), 2.4 parts by weight of an H-containing siloxane (cross-linking agent V90) and 1 part by weight of Pt catalyst (catalyst OL) was applied to the paper thus primed, and the coated paper was heated at 150° C. for 7 seconds.

Test Methods:

Migration Test:

A test adhesive tape was applied to the freshly siliconized side and then peeled off again. The adhesive strip was folded together so that the adhesive surfaces touched. The ends were then pulled apart (loop test). If the layers adhering to one another have good adhesion, this indicates good adhesion of the silicone layer on the substrate. Both tests are rated from 1 to 6:1=very good, 6=very poor.

Ruboff:

The siliconized surface is rubbed forcefully once with a finger and the area is viewed in obliquely incident light. If differences in brightness or stripes occur in this area, the silicone product is not adhering optimally. In addition, the silicone layer is rubbed several times strongly with a finger, and the amount of abrasion particles is observed. Both tests are rated from 1 to 6.

Results:

| | Example 2 |
|---|---|
| Migration | 1 |
| Ruboff | 1 |

1.-11. (canceled)

12. A silane-modified polyvinyl alcohol prepared by free-radical polymerizing one or more vinyl esters in the presence of one or more epoxide-functional comonomers, subsequently silylating the epoxide groups with one or more nucleophilic silane compounds to obtain a silane-modified vinyl ester copolymer, and hydrolyzing the silane-modified vinyl ester copolymer.

13. The silane-modified polyvinyl alcohol of claim 12, wherein the vinyl ester used comprises vinyl acetate.

14. The silane-modified polyvinyl alcohol of claim 12, wherein the epoxide-functional comonomer comprises glycidyl acrylate or glycidyl methacrylate.

15. The silane-modified polyvinyl alcohol of claim 13 wherein the epoxide-functional comonomer comprises glycidyl acrylate or glycidyl methacrylate.

16. The silane-modified polyvinyl alcohol of claim 12, wherein the epoxide-functional comonomer is polymerized in a proportion of from 0.01 to 10.0 mol %, based on the total amount of the comonomers.

17. The silane-modified polyvinyl alcohol of claim 13, wherein the epoxide-functional comonomer is polymerized in a proportion of from 0.01 to 10.0 mol %, based on the total amount of the comonomers.

18. The silane-modified polyvinyl alcohol of claim 14, wherein the epoxide-functional comonomer is polymerized in a proportion of from 0.01 to 10.0 mol %, based on the total amount of the comonomers.

19. The silane-modified polyvinyl alcohol of claim 12, wherein one or more nucleophilic silane compounds selected from the group consisting of aminoalkyl-functional silanes, hydroxyalkyl-functional silanes, and mercaptoalkyl-functional silanes, and having at least one C₁₋₆ alkoxy group, are used as the nucleophilic silane compound.

20. The silane-modified polyvinyl alcohol of claim 16, wherein one or more nucleophilic silane compound selected from the group consisting of aminoalkyl-functional silanes, hydroxyalkyl-functional silanes, and mercaptoalkyl-functional silanes and having at least one C₁₋₆ alkoxy group, are used as the nucleophilic silane compound.

21. The silane-modified polyvinyl alcohol of claim 19, wherein at least one nucleophilic silane compound is selected from the group consisting of aminoalkoxysilanes, aminoalkyldialkoxyalkylsilanes, aminoalkyldialkylalkoxysilanes, mercaptoalkylalkoxysilanes, mercaptoalkyldialkoxyalkylsilanes, mercaptoalkyldialkylalkoxysilanes, hydroxyalkylalkoxysilanes, hydroxyalkyldialkoxyalkylsilanes, and hydroxyalkyldialkylalkoxysilanes.

22. A process for the preparation of a silane-modified polyvinyl alcohol of claim 12, comprising free-radical polymerizing one or more vinyl esters in the presence of one or more epoxide-functional comonomers, subsequently silylating the epoxide groups with one or more nucleophilic silane compounds to obtain a silane-modified vinyl ester copolymer, and hydrolyzing the silane-modified vinyl ester copolymer.

23. The process of claim 22, wherein the vinyl ester copolymers are prepared by polymerizing in organic solvent, and the epoxide-functional vinyl ester copolymers obtained thereby are silanized in solution with one or more silane compounds selected from the group consisting of silanes substituted by aminoalkyl, hydroxyalkyl or mercaptoalkyl radicals and having at least one alkoxy group, wherein the alkyl radical(s) and alkoxy radical(s) have 1 to 6 C atoms, and the silane-modified polyvinyl alcohols obtained thereby are hydrolyzed to a degree of hydrolysis of from 50 mol % to 99.99 mol %.

24. In an aqueous coating system for the production of recording materials or an additive for the production of release paper stocks in which a polyvinyl alcohol polymer is employed, the improvement comprising adding as at least a portion of the polyvinyl alcohol polymer, a silane-modified polyvinylalcohol polymer of claim 12.

25. In an adhesive formulation or a coating material for use in packaging in which a polyvinyl alcohol polymer is employed, the improvement comprising adding as at least a portion of the polyvinyl alcohol polymer, a silane-modified polyvinylalcohol polymer of claim 12.

26. In an agrochemical formulation wherein a binder is employed, the improvement comprising selecting as at least one binder, a silane-modified polyvinylalcohol of claim 12.
